(19) United States
(12) Patent Application Publication
(10) Pub. No.: US 2006/0191745 A1
(43) Pub. Date: Aug. 31, 2006

(54) Adjustable leg extension

(76) Inventor: Kevin L. McAllister, American Fork, UT (US)

Correspondence Address: THORPE NORTH & WESTERN, LLP., 8180 SOUTH 700 EAST, SUITE 200, SANDY, UT, 84070, US

(21) Appl. No.: 11/352,444

(22) Filed: Feb. 9, 2006

Related U.S. Application Data
(60) Provisional application No. 60/650,896, filed on Feb. 9, 2005.

(51) Int. Cl. E06C 7/16

(52) U.S. Cl. 182/121

(57) ABSTRACT

A leg extension device comprises at least two support posts and at least two cross members, pivotally coupled to and constraining the at least two support posts in a substantially parallel relationship. A foot support platform is configured to receive a foot of a wearer to support the wearer on the leg extension device. The foot support platform is slidably coupled aside each of the at least two support posts. An interlock mechanism is operable to engage the foot support platform to selectively restrict movement of the foot support platform relative to the support posts to allow adjustment of a height of the foot support platform.

### PRIORITY DATA

This application claims priority to U.S. Provisional Patent Application Ser. No. 60/650,896, filed Feb. 9, 2005, which is hereby incorporated herein in its entirety.

### FIELD OF THE INVENTION

The present invention relates generally to leg extension devices that can be used to elevate a user when worn on the user's feet. More particularly, the present invention relates to leg extension devices that can be adjusted while the user is mounted on the leg extension devices.

### BACKGROUND OF THE INVENTION

Leg extension devices, or stilts, have been used for some time in numerous endeavors, including applications for both utility and amusement. For example, leg extension devices have been used by construction workers to perform tasks that would otherwise require a ladder or scaffolding system to elevate the worker to a position where he or she can safely and effectively perform the tasks. In particular, drywall “hangers” and “mudders” have found leg extension devices useful when hanging drywall or applying drywall “mud” to ceilings or walls that are out of reach of the worker from ground or floor level.

A variety of commercially available leg extensions have been made available for these purposes. Examples of such devices are discussed in U.S. Pat. No. 3,102,272, U.S. Pat. No.

3,902,199, U.S. Pat. No. 5,645,515, U.S. Pat. No.

6,283,462, U.S. Pat. No.

6,517,586 and U.S. Pat. No. 6,648,803. It is believed that one of the most popular features of these types of leg extensions is the so-called parallelogram, or four-bar linkage, assembly in which two upright posts are constrained at a lower end by a pseudo-foot assembly and constrained at an upper end by a foot-receiving plate or platform to which, or onto which, a user's foot is coupled. The four-bar linkage assembly aids in providing “feedback” to the user, allowing the user to sense contact with both the toe and the heel of the lower, pseudo-foot assembly and the ground or floor. In this manner, the user is better able to mimic a natural walking condition when wearing the leg extension.

While such devices have found some commercial success, they suffer from several limitations. For example, many commercially available leg extension devices are not adjustable in height, providing a fixed degree of elevation that may be helpful in only a limited number of applications. While other leg extensions devices have been provided with height adjustability, the height adjustment has been limited and can interfere with or counter some of the benefits provided by the four-bar linkage assembly. For example, many of the adjustable-height leg extensions have been made adjustable by simply allowing a lower portion of the upright support posts to telescopically extend downwardly from a lower portion of the upright support posts. When it is desired to adjust a height of these conventional leg extensions, an inner component of the upright support posts is slid within an outer component until the desired height is achieved. Thus, in an effort to provide height-adjustability, the feedback portion of the leg extensions (e.g., the parallel-linkage assembly) has been modified to include height adjustment. This can result in the “feel” of the leg extension to vary depending upon the height at which the leg extensions are adjusted.

In addition, it has been found that for a leg extension device to provide sufficient height adjustability to perform in a variety of applications, the leg extension device should adjust from about 12 inches in height to about 40 inches in height. If a telescopically-adjusting system is designed to be operated at a height as low as 12 inches, it generally can extend to a maximum height of no more than about 22 inches. Thus, conventional adjustable-height systems have not provided a sufficient range of height adjustment for many applications. Because of this, a line of adjustable-height leg extension products has been necessary, with one model provided for adjustment from 14 inches to 22 inches, with another model for 18 inches to 30 inches, and with another model from 24 inches to 40 inches.

In addition to the problems associated with obtaining a wide range of height adjustment with conventional leg extensions, the height adjustment on these models can generally only be made by removing a bolt or pin from the telescopic linkage, extending the telescoping member to the desired position, and reinstalling the bolt or pin to secure the length of the linkage. This process often requires the user to remove the leg extensions to make the adjustment, which can require that the user dismount from the leg extension, and remove two or three foot straps and a leg strap to disengage his or her foot from the leg extension. This process is obviously very tedious and reduces the efficiency of any given task while also increasing the likelihood of an accident occurring during the many mounts and dismounts that may be required to complete a particular task.

### SUMMARY OF THE INVENTION

Accordingly, the present invention provides a leg extension device that can include at least two support posts and at least two cross members, pivotally coupled to and constraining the at least two support posts in a substantially parallel relationship. A foot support platform can be configured to receive a foot of a wearer to support the wearer on the leg extension device. The foot support platform can be slidably coupled aside each of the at least two support posts. An interlock mechanism can be operable to engage the foot support platform to selectively restrict movement of the foot support platform relative to the support posts to allow adjustment of a height of the foot support platform.

In accordance with another aspect of the invention, a leg extension device is provided, including a support frame that can include: at least two support posts, a first cross member pivotally coupled to the at least two support posts at a first elevation, and a second cross member pivotally coupled to the at least two support posts at a second elevation relatively lower than the first elevation. A foot support platform can be movable independently from the support frame and can be slidably coupled to at least one of the support posts between the first and second cross members. An interlock mechanism can be operable to engage the foot support platform to selectively restrict movement of the foot support platform relative to the support posts to allow adjustment of a height of the foot support platform.

In accordance with another aspect of the invention, a method for forming a height-adjustable leg extension device is provided, including the steps of: providing a load-bearing parallel linkage assembly configured to simulate motion of a human foot, the parallel linkage assembly including at least two support posts pivotally coupled to at least two cross members; slidably coupling a foot support platform to the parallel linkage assembly, the foot support platform being configured to receive a user's foot; and operably coupling an interlock mechanism to each of the foot support platform and the parallel linkage assembly, the interlock mechanism being operable to selectively restrict movement of the foot support platform relative to the support posts to allow adjustment of a height of the foot support platform.

In accordance with another aspect of the invention, a leg extension device is provided, including at least one support post and at least one foot support platform, pivotally coupled to the support post. A floor pad can be pivotally coupled to the support post. An interlock mechanism can be operable to engage the foot support platform to selectively restrict movement of the foot support platform relative to the floor pad to allow adjustment of a height of the foot support platform. A linkage assembly can be coupled to each of the foot support platform and the floor pad. The linkage assembly can be operable to maintain a substantially constant angular differential between the foot support platform and the floor pad as the foot support platform and the floor pad pivot relative to the support post. The foot support platform can be free to pivot relative to the support post but for one or more restraining forces applied by the linkage assembly to the foot support platform.

There has thus been outlined, rather broadly, relatively important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a perspective view of a leg extension device in accordance with an embodiment of the invention;

FIG. 2 is an end view of a leg extension device in accordance with another aspect of the invention;

FIG. 3 is a rear view of an interlock mechanism of the leg extension device of FIG. 1, shown with the foot support pad removed from the leg extension device;

FIG. 4 is a perspective view of an interlock mechanism in accordance with another aspect of the invention;

FIG. 5 is a rear view of an interlock mechanism in accordance with an aspect of the invention;

FIG. 6 is a perspective view of another leg extension device in accordance with an embodiment of the invention;

FIG. 7 is an end view of an interlock mechanism of the leg extension device of FIG. 6;

FIG. 8 is a front view of another leg extension device in accordance with an embodiment of the invention;

FIG. 9 is a rear view of another leg extension device in accordance with an embodiment of the invention;

FIG. 10 is a front view of another leg extension device in accordance with an embodiment of the invention;

FIG. 11A is a front view of another leg extension device in accordance with an embodiment of the invention; and

FIG.11B is an end view of the leg extension device of FIG. 11A.

### DETAILED DESCRIPTION

Before the present invention is disclosed and described, it is to be understood that this invention is not limited to the particular structures, process steps, or materials disclosed herein, but is extended to equivalents thereof as would be recognized by those of ordinarily skilled in the relevant arts. It should also be understood that terminology employed herein is used for the purpose of describing particular embodiments only and is not intended to be limiting.

It must be noted that, as used in this specification and the appended claims, the singular forms “a” and “the” include plural referents, unless the context clearly dictates otherwise. Thus, for example, reference to a “leg extension device” includes one or more of such leg extension devices.

Definitions

In describing and claiming the present invention, the following terminology will be used in accordance with the definitions set forth below.

As used herein, the terms “upper,” “lower,” “elevation,” “height,” and the like, are to be understood to refer to relative locations of various components of the invention, using a convention relative to a condition when the leg extension device is oriented in its usable, upright orientation. Thus, in the upright orientation, the foot support platform of the leg extension device will be at a greater (or higher) elevation (or height) than will be the floor pad of the leg extension device. In general, zero elevation or height is to be understood to refer to floor or ground level (upon which the floor pad of the leg extension device rests).

Distances, angles, forces, weights, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 inch to about 5 inches” should be interpreted to include not only the explicitly recited values of about 1 inch to about 5 inches, but also include individual values and sub-ranges within the indicated range. This same principle applies to ranges reciting only one numerical value and should apply regardless of the breadth of the range or the characteristics being described.

The figures used to illustrate various features of the present invention are presented to provide a better understanding of the invention and do not necessarily limit the invention. Some of the figures are presented as schematic representations of features of the invention and not necessarily drawn to scale and do not necessarily accurately represent spatial relationships between features of the leg extension devices. Some aspects of the leg extension devices may be omitted from some figures in the interest of describing the invention in the most easily understood manner.

Invention

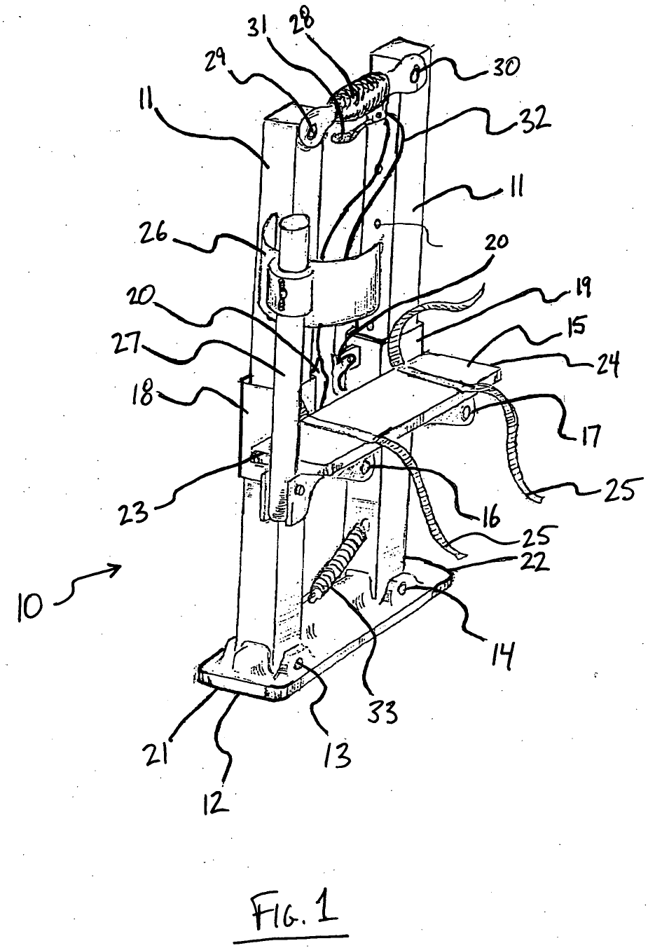

As shown generally at 10 in FIG. 1, in one embodiment, the invention provides a leg extension device that can be used to elevate a user above a ground or floor level (not shown). The leg extension device can include one or more support posts 11 and one or more cross members 12, 28, that, in the embodiment shown, comprise a floor pad 12 and a handle 28. The cross members can be pivotally coupled to and can constrain the support posts in a substantially parallel relationship. A foot support platform 15 can be configured to receive a foot (not shown) of a wearer to support the wearer on the leg extension device. The foot support platform can be slidably coupled aside each of the support posts. An interlock mechanism, which can include actuatable mechanical locks 20, flexible members 32, and lever 31, can be operable to engage the foot support platform to selectively restrict movement of the foot support platform relative to the support posts to allow selective adjustment of a height of the foot support platform.

The floor pad 12 can include rear floor pivot 13 and front floor pivot 14. Similarly, the handle 28 can include rear handle pivot 29 and front handle pivot 30. The floor pivots and handle pivots can be spaced substantially the same distance from one another to maintain the support posts 11 in a substantially parallel relationship. In this manner, the floor pad, handle and two support posts define a parallelogram, parallel bar linkage or four-bar linkage. Utilization of such a configuration results in the support posts 11 being maintained in a substantially parallel relationship, even when angled forwardly or backwardly from the generally vertical upright position. In this manner, the foot support platform 15, which can be slidably coupled to the support posts, is free to slide upwardly or downwardly on the support posts to a variety of elevational locations.

The foot support platform 15 can be provided in a variety of configurations, including the generally planar configuration shown in the figures. It is also contemplated that a shoe-like receiving cup (not shown) can be incorporated into or onto the support platform. Straps 25 can be coupled to the foot support platform to provide a manner of securing the user's foot to the platform. The support platform can be slidably coupled to the support posts 11 by way of a pair of collars 18, 19, to which the support platform can be rotatably coupled via rear pivot connection 16 and front pivot connection 17.

The collars 18, 19 shown in the figures are generally rectangular is cross section and can substantially completely circumscribe the support posts 11 to securely engage the support posts. It is to be understood, however, that the collars can only partially circumscribe the support posts, as would be the case, for example, when the collars are formed with a “C”-shaped cross section. In other embodiments of the invention, the foot support platform 15 can be slidably coupled to the support posts in a manner that does not utilize collars. For example, the foot support platform can include notched protrusions (not shown) that engage longitudinal slots (not shown) in the support posts that allow the platform to slide upwardly or downwardly relative to the support posts without allowing lateral movement of the platform away from the support posts.

By slidably coupling the support platform to the support posts, the support platform can be located at a variety of heights along the support posts. By rotatably coupling the support platform to the support posts, the support platform is allowed to pivot in the same manner as does the foot pad 12. Thus, as a user walks while mounted on the leg extension device 10, his or her foot moves the foot support platform and the floor pad 12 in unison (along with the handle 28). In this manner, the floor pad serves as an extension of the foot support platform and provides the user with sensory feedback throughout the walking motion.

By slidably attaching the foot support platform 15 to the support posts 11, the present invention decouples two of the major design considerations in the leg extension device: the weight supporting frame and the height adjustment capability. In this manner, the four-bar linkage frame can be designed and manufactured to provide the best freedom of movement and strength without regard to height adjustment. Similarly, the height adjustment mechanism can be designed to provide maximum height adjustment with ease of adjustability. Thus, in one embodiment of the invention, the foot support platform can move independently of the support frame with which the foot support platform is associated.

A leg support 26 can be provided to enhance stability of the leg extension device while coupled to a user's foot. The leg support can be pivotally coupled proximate the heel 23 of the foot support platform 15. The leg support can be adjusted upwardly and downwardly on leg support post 27 to provide a high degree of comfort level and secure connection to the user's leg. An articulation resistance member 33 (in the embodiment shown, a linear spring) can aid in providing stiffness to the leg extension device to limit rotation of the device and provide resistance similar to that encountered during normal walking.

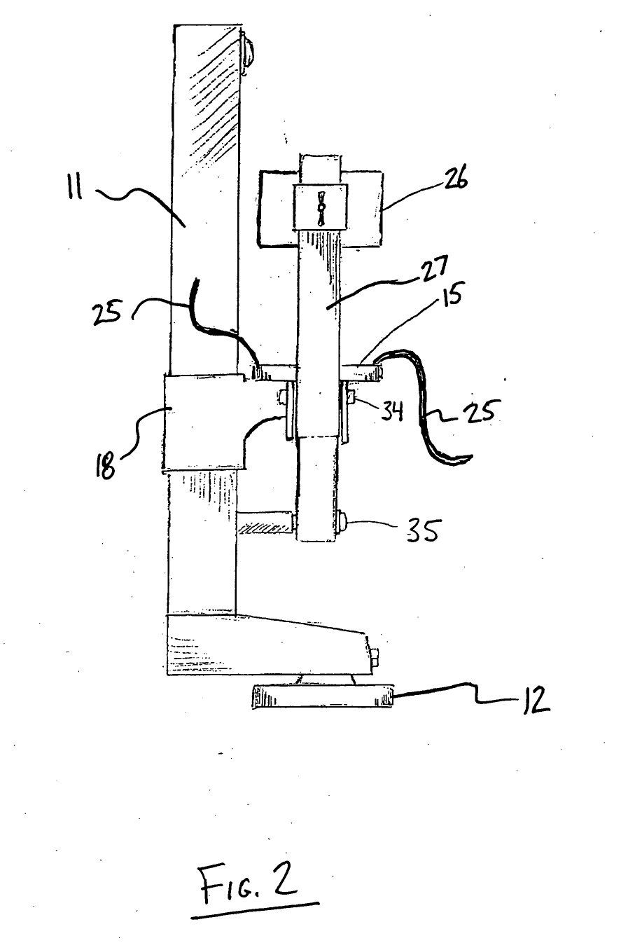

As shown in FIG. 2, the floor pad 12 can be oriented so as to be aligned in a vertical plane with foot support platform 15. In this manner, any negative affects of side loading due to the offset nature of the foot support platform relative to the support posts 11 can be negated or limited.

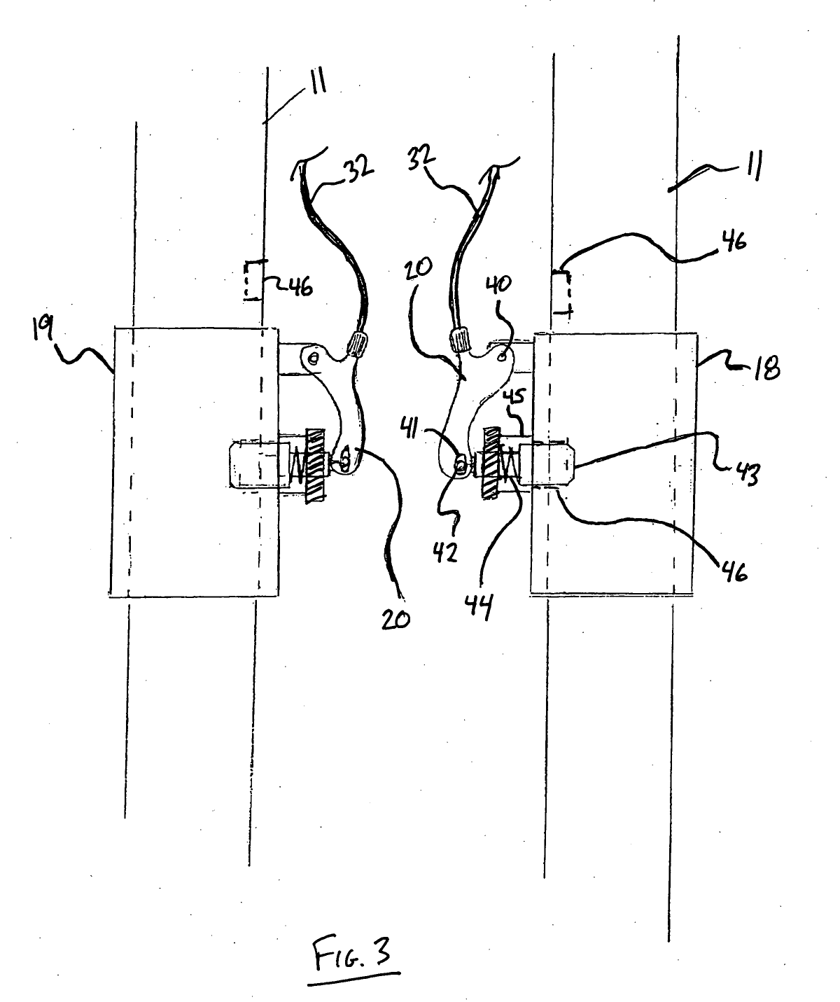

FIG. 3 shows a more detailed view of the leg extension device 10 of FIG. 1 wherein the interlock mechanism includes mechanical locks 20. The mechanical locks 20 can include actuatable pins 43 that can be configured to be engaged in receiving apertures 46 formed in the support posts 11. It will be appreciated that, when in a normally closed position, the actuatable pins 43 engage the receiving apertures 46 and limit movement of the collars 18, 19 relative to the support posts. Mechanical locks 20 rotate about pivot 40 when actuated by flexible members 32 (which are actuated by lever 31 shown in FIG. 1). Thus, when it is desired to adjust a height of the collars 18, 19 relative to the support posts 11, a user simply grasps (e.g., squeezes) lever 31 to thereby rotate mechanical locks 20, which results in actuatable pins 43 disengaging from the apertures 46. The collars (and thereby the foot support platform 15) can then be adjusted as desired until the pins are positioned over an alternate aperture, at which point the user can release the lever and biasing element 44 will force the pins into the alternate aperture, thereby locking the foot support platform in the new location.

A guide tube or collar 45 can serve to maintain the actuatable pins 43 in position while the pins are retracted or inserted into apertures 46. The mechanical lock 20 can include a slotted end 41 that can engage a pin or protrusion 42 on the actuatable pins 43 to maintain contact between the pins 43 and the locks 20.

It will be appreciated that the actuation device, or lever 31, of the embodiments discussed can be easily accessed by a user of the present device, even when the user is mounted on the leg extension devices 10 (e.g., when the user is supported by the leg extension devices). In this manner, a user need not dismount from the leg extension devices in order to adjust the height of the foot support platform 12. In a typical scenario, if a user need adjust the height of one or both extension devices he or she is wearing, he or she need only remove a majority of his or her weight from the device to be adjusted, grasp lever 31, adjust the platform location relative to the support posts 11, then proceed with adjusting the extension .device on his or her other leg, or proceed with the task at hand, as the case may be.

In some embodiments of the invention, the actuation device (e.g., lever 31) is disposed at a height equal to or greater than a height of the foot support platform when the foot support platform is in a position of maximum height adjustment. In this manner, a great majority of users of the extension device will be able to adjust the height of the extension device while wearing the same.

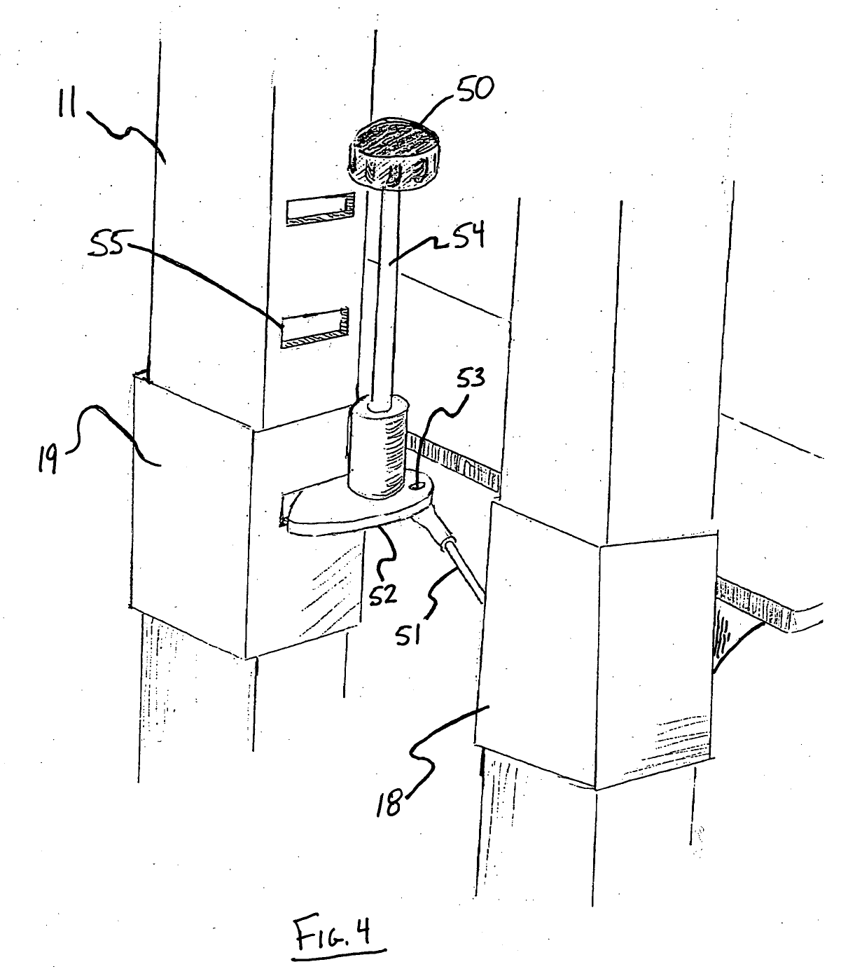

While not so required, actuation of the actuation device (e.g., lever 31) can result in the pins 34 associated with both the support posts 11 being extracted from their respective apertures 46. However, it is contemplated that each pin can be actuated independently of the other. FIG. 4 illustrates an alternate embodiment of the interlock mechanism in which actuation knob 50 can be mechanically linked to a lock plate 52 by a rigid member 54. As the knob 50 is turned, the rigid member 54 can rotate the lock plate 52 to thereby extract it from a slot 55 in the support post 11. The sliding bracket 18 can then move freely upwardly or downwardly on the support post. A connecting link 51 can be utilized to drive lock plates 52 on both sliding brackets 18 with a single actuation knob 50. The connecting link 51 can be oriented such that it does not impede articulation of the support posts 11 during use of the extension device.

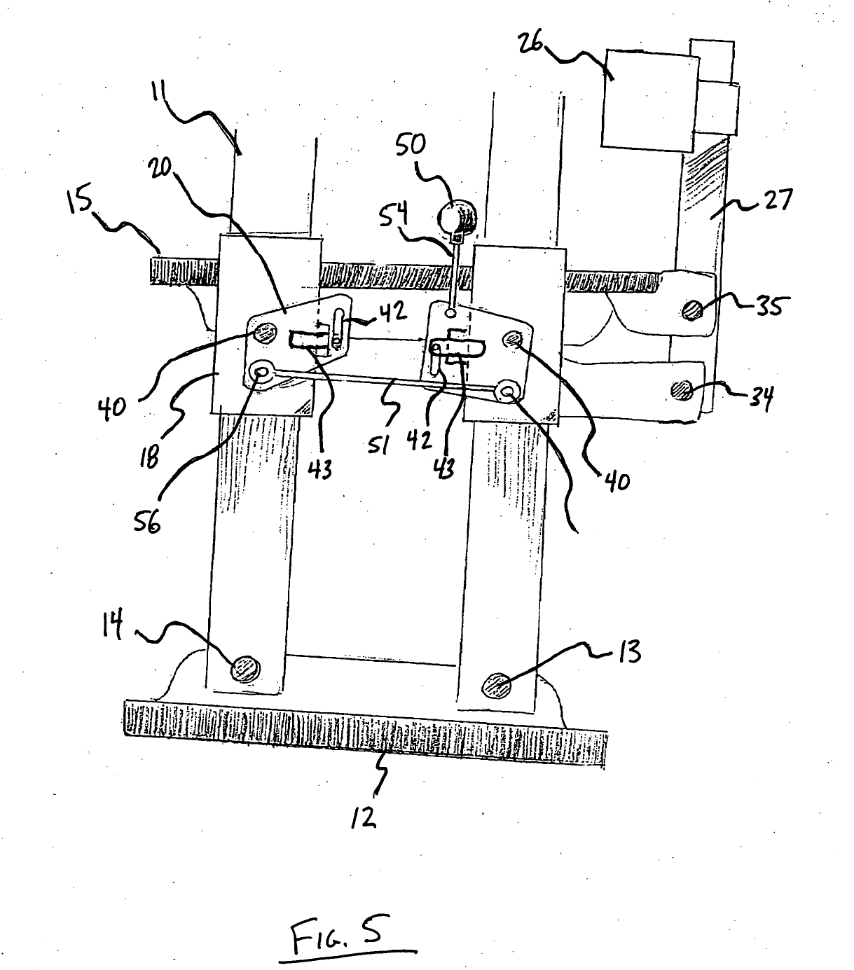

In the embodiment of the invention shown in FIG. 5, actuation knob 50 is associated with rigid member 54 and lock pin 43. Slot 42 engages locking pin 43. As actuation knob 50 is pulled through essentially linear, side-to-side movement, rigid member 54 causes the actionable mechanical lock 20 to rotate about a base pivot 40 while the slot 41 pushes on the cross pin 42 and retracts the lock pin 43 from the parallel post 11. A connecting link 51 can allow the actuation knob 50 to operate two actionable locks simultaneously. By spacing base pivots 40 and link pivots 56 substantially the same as the rear 13 and front 14 floor pivots are spaced, articulation of the support posts 11 is not inhibited during use of the leg extension device.

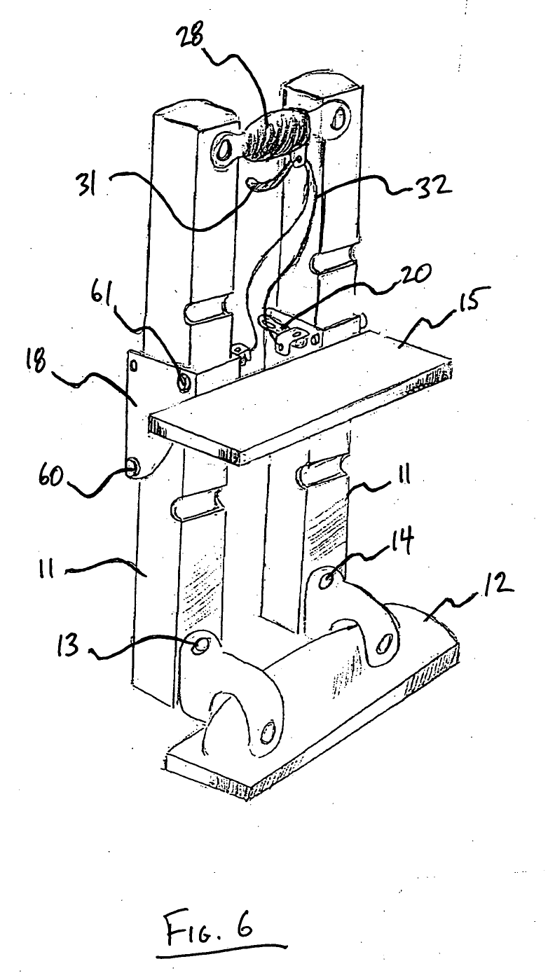

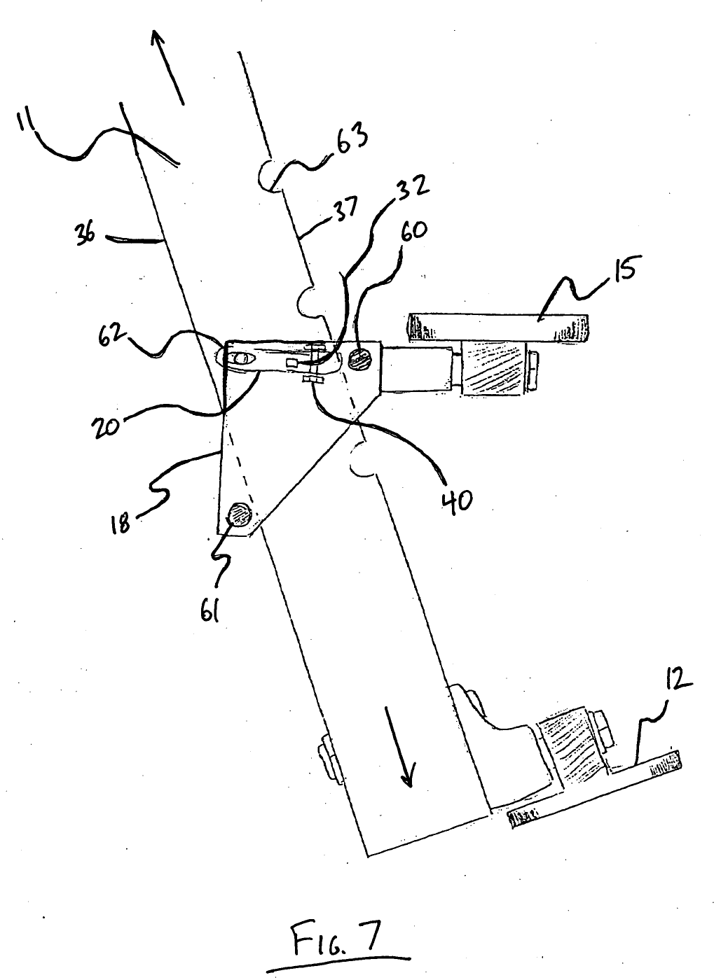

FIGS. 6 and 7 illustrate another embodiment of the invention in which components similar to those discussed above can be found. Floor pad 12, foot support platform 15, support posts 11, handle 28, lever 31, and flexible member 32 are incorporated into this embodiment. In this aspect of the invention, actuatable mechanical lock 20 can control the movement of a retaining member 62. An upper contact 60, lower contact 61, and a retaining member 61 can be disposed on sliding bracket 18. When the sliding bracket 18 is secured to the parallel post 11, the upper contact 61 can seat in receiver 63 on the inner face 37 on the parallel post 11 while the lower contact 61 and retaining member 62 can be positioned just outside of the outer face 36. In this manner, load applied to the foot support platform 15 is supported by the upper contact 60 seated in the receiver 63 while retaining member 62 prevents undesired rotation of the foot pad 15 and the sliding bracket 18.

Upper contact 60 can thus become the fulcrum for the load applied to the foot support platform 15 while also providing vertical support to the user. During adjustment of the elevation of the foot pad, the actuatable mechanical lock 20 can retract the retaining member 62 so that the sliding bracket 18 can rock inward and the upper contact 60 can be unseated from the receiver 63. The sliding bracket is then free to move up or down the support post 11. At the desired position, the upper contact 60 can be seated in a receiver 63 and the retaining member 62 can be deployed to lock the sliding bracket 18 in position. In this embodiment, the lower contact 61 can serve only to prevent the support post 11 from being retracted out of the sliding bracket 18 during adjustment.

It is to be understood that the upper contact 60, lower contact 61, and retaining member 62 can be arranged in various configurations to accomplish the function of securing the sliding bracket 18 on the support post 11. Further, it is to be understood that the receiver 63, which offers vertical support, can be positioned on one or more different faces of the support post.

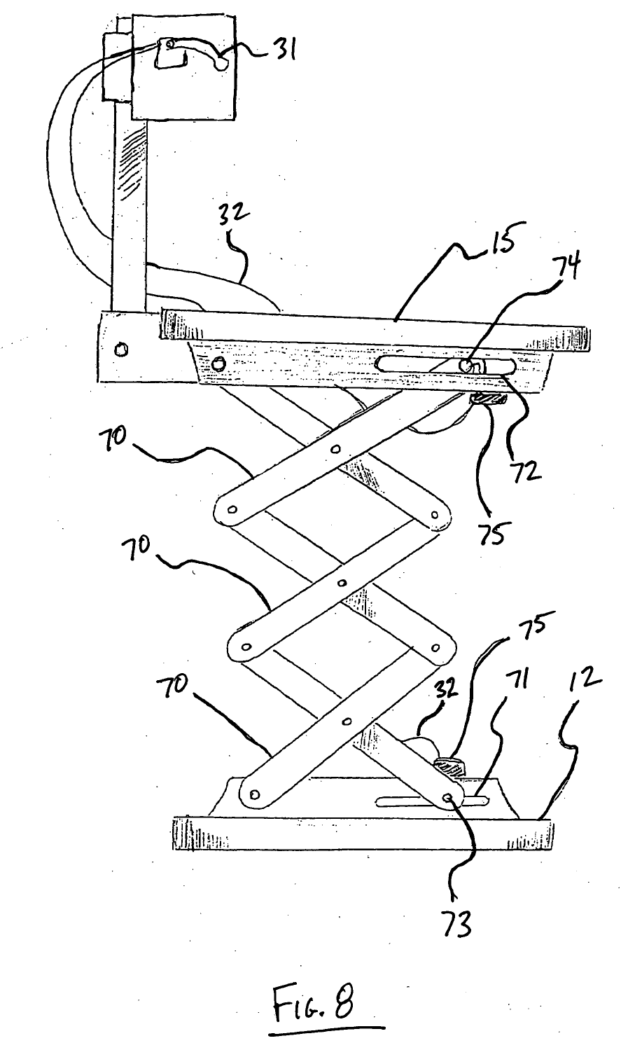

FIG. 8 illustrates another embodiment of the adjustable leg extension 10. In this aspect, scissor links 70 can be disposed between the floor pad 12 and the foot support platform 15. The scissor links 70 provide a compact manner of obtaining significant motion. Unlike the previous embodiments, the scissor link embodiment obtains an expanded range of adjustment in the leg extension 10 by virtue of the improved ability to achieve greater translation from the same closed height than single stage telescopic techniques employed in the prior art. Although there are more parts required in the scissor links 70, the primary advantage over conventional extension devices is the elimination of parallel posts.

Slot locks 75 can secure the floor slide pivot 73 in the floor pad slot 71 and the foot slide pivot 74 in the foot pad slot 72 to maintain a desired height of the foot support platform 15. The slot locks 75 can use pins, teeth, or other methods to secure the floor slide pivot 73 and foot slide pivot 74. As with previous embodiments, the use of a lever 31 and flexible members 32 enables the user to make the height adjustments without dismounting from the leg extension 10.

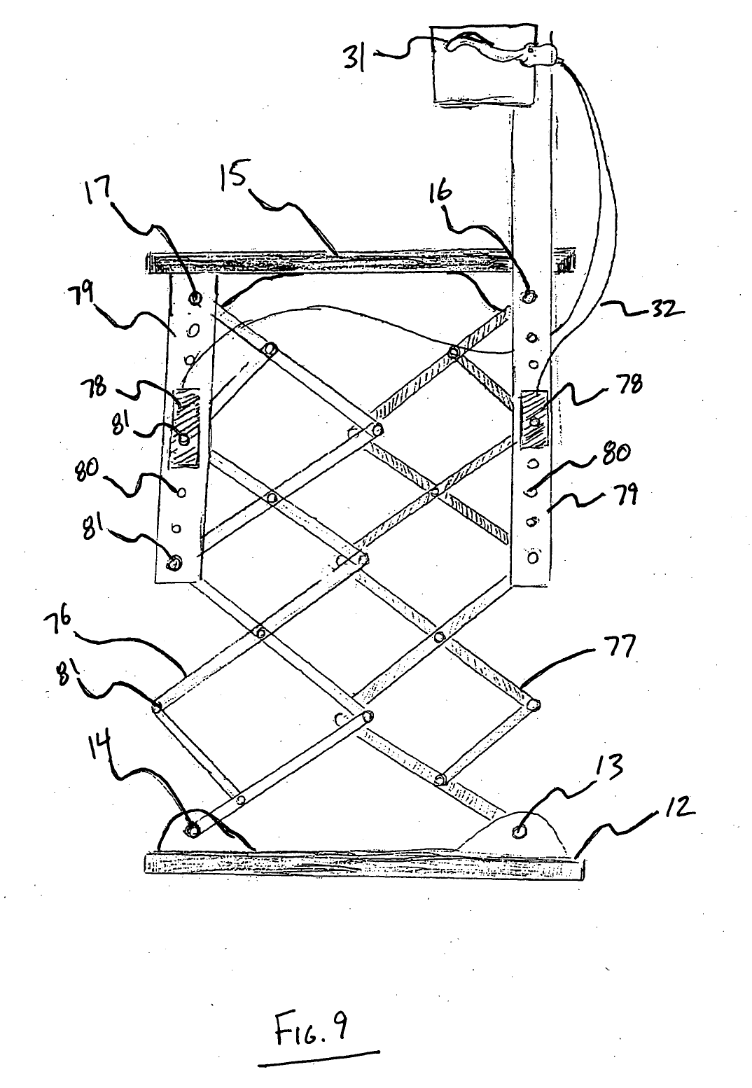

FIG. 9 illustrates another embodiment of the invention, where front scissor linkage 76 can serve as a front link and rear scissor linkage 77 can serve as a rear link. The front scissor linkage 76 can be secured at a set length with a scissor lock 78 that can engage a slide rail 79 by means of pins, teeth, or other mechanisms described previously. The front slide rail 79 can pivot on the front foot pivot 17 and can surrounds the front pivots 81 of the front scissor linkage 76. As the front scissor linkage 76 changes length the front pivots 81 moves up and down the slide rail 79. By securing the topmost front pivot 81 at various positions in the slide rail 79 the front scissor linkage 76 is set to various lengths.

The rear scissor linkage 77 can function in substantially the same manner as the front scissor linkage 76. The front scissor linkage 76 can serve as a single link connecting the front foot pivot 17 and the front floor pivot 14. The rear scissor linkage 77 can serve as a single link connecting the rear foot pivot 16 and the rear floor pivot 13. Thus, two independent scissor linkages can be used to create the four bar linkage utilized in other embodiments of the present invention discussed herein. The front scissor linkage 76 and the rear scissor linkage 77 can share separate planes and thereby overlap to create a more compact height adjustment mechanism for the leg extension. As with other embodiments, levers 31 and flexible members 32 can be used to enable the user to operate the scissor locks 78 without dismounting.

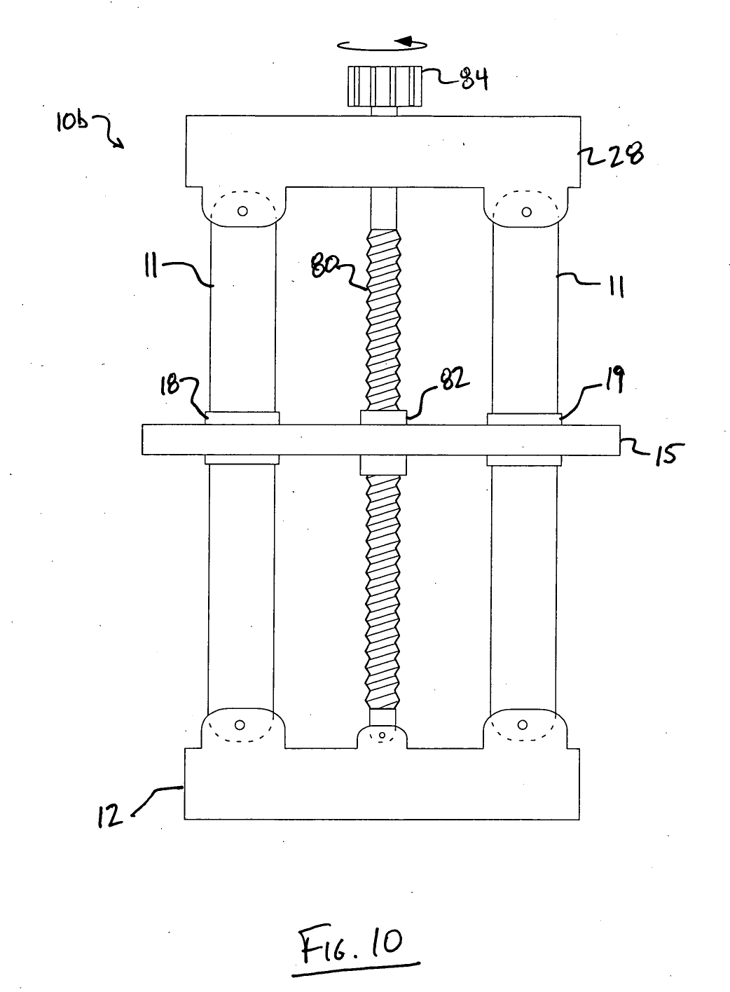

FIG. 10 illustrates yet another aspect of the invention, wherein leg extension device 10b includes an interlock mechanism that can include a threaded rod 80 that can be oriented substantially parallel to the support posts 11. A threaded receiver 82 can be associated with the foot support platform 15. An actuation knob 84 can be coupled to the threaded rod such that rotation of the knob 84 results in rotation of the threaded rod. In this embodiment of the invention, elevational adjustment of the foot support platform 15 is achieved by rotating knob 84, which rotates threaded rod 80, which results in receiver 82 moving up or down the rod (depending upon the direction of rotation of the rod). As the receiver moves up or down the rod, the foot support platform (which is coupled to the receiver) is also moved up or down.

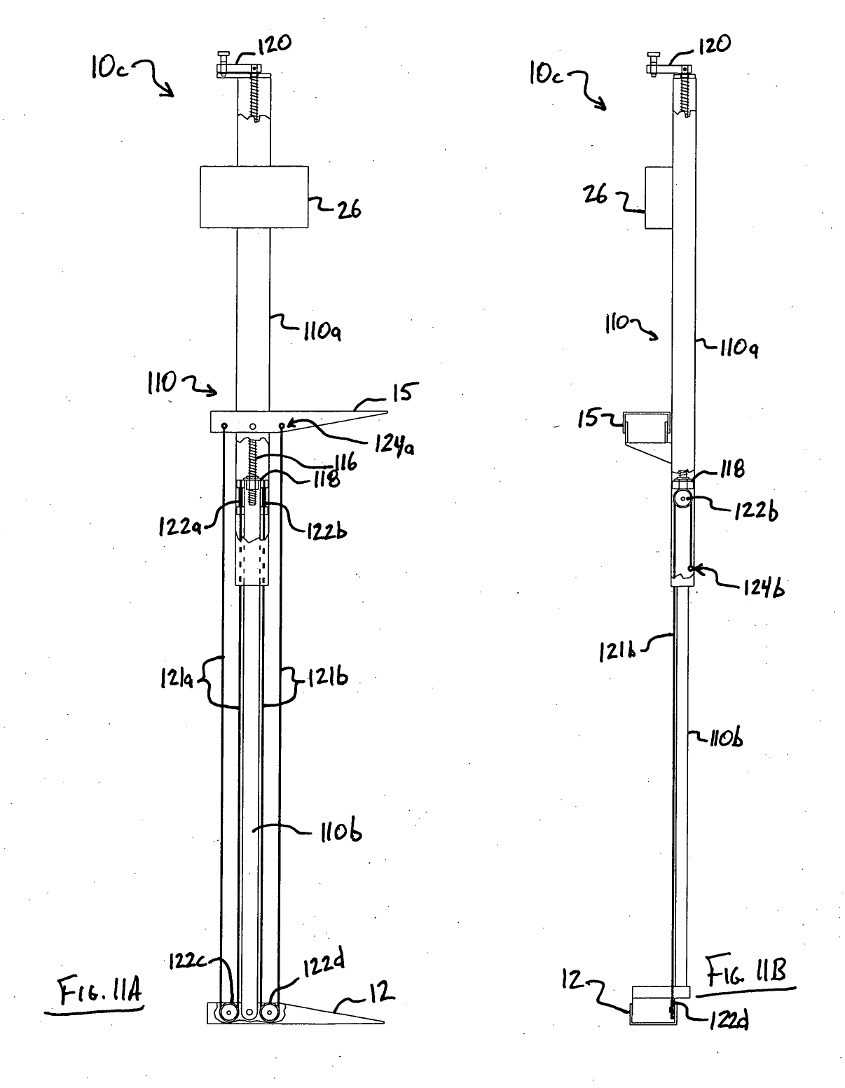

Turning now to FIGS. 11A and 11B, in one embodiment of the invention, a leg extension device 10c is provided. The extension device 10c can include at least one support post 110 and at least one foot support platform 15, pivotally coupled to the support post. A floor pad 12 can be pivotally coupled to the support post. An interlock mechanism (discussed in more detail below) can be operable to engage the foot support platform to selectively restrict movement of the foot support platform relative to the floor pad to allow adjustment of a height of the foot support platform. A linkage assembly (discussed in more detail below) can be coupled to each of the foot support platform and the floor pad. The linkage assembly can be operable to maintain a substantially constant angular differential between the foot support platform and the floor pad as the foot support platform and the floor pad pivot relative to the support post. The foot support platform can be free to pivot relative to the support post but for one or more restraining forces applied by the linkage assembly to the foot support platform.

In the embodiment shown, the support post includes an upper section 110a and a lower section 110b. The interlock mechanism can include a threaded rod 116 that extends through the upper section and is threadably coupled to the lower section via engagement assembly 118. An engagement knob 120 can be coupled to the threaded rod such that rotation of the knob results in rotation of the rod. As the rod rotates, the lower section of the support post is adjusted upwardly or downwardly (depending upon the direction of rotation of the rod), relative to the upper section. Thus, a wearer of the leg extension device can adjust a height of the foot support platform 15 relative to the foot pad 12 (e.g., relative to a floor or ground surface, not shown) while the wearer is mounted upon the leg extension device.

In the embodiment shown in FIGS. 11A and 11B, the linkage assembly includes a pair of flexible cables 121a, 121b that can be engaged with one or more pulleys 122a, 122b, 122c and 122d. As shown by example by cable 121b, one end of the flexible cable 121b can be coupled to the foot support platform 15 at location 124a and can extend downwardly about pulley 122d and back to pulley 122b (which is coupled to the upper section 110a of the support post), after which it can extend downwardly again to connection location 124b (FIG. 11B). This same relationship can be shared by flexible cable 121a, which is engaged with pulleys 122a and 122c. In this manner, each of the flexible cables can form a fixed length of cable routed about at least two pulleys. As the upper section 110a of the support post 110 is adjusted upwardly or downwardly, the amount of cable disposed between the pulleys can continuously vary such that cable 121a is always tensioned between pulley 122a and 122c and cable 121b is always tensioned between pulley 122b and 122d.

The pulleys 122 and cables 121 of the linkage assembly can serve to continuously maintain a substantially constant angular differential between the foot support platform 15 and the foot pad 12. In the case shown in FIGS. 11A and 11B, the angular differential between the foot support platform and the foot pad is substantially zero degrees, e.g., the foot support platform and the foot pad are substantially parallel to one another. This embodiment of the invention can ensure that, when the foot pad becomes slanted from horizontal, as may be the case, for example, during a normal walking gate, the foot support platform is also forced into a slant, to the same degree of change from horizontal. This can aid a wearer of the leg extension device in maintaining a more or less normal walking gait while utilizing the leg extension device, as both the foot support platform and the foot pad can slant forwardly and backwardly from horizontal while the wearer walks about.

The linkage assembly shown can accomplish the maintenance of the substantially constant angular differential between the foot support platform 15 and the foot pad 12 regardless of the height at which the foot support platform is adjusted. The linkage assembly can also maintain the angular differential while the height of the foot support platform is being adjusted.

In addition to the structure outlined above, the present invention also provides a method for forming a height-adjustable leg extension device which can include the steps of: providing a load-bearing parallel linkage assembly configured to simulate motion of a human foot, the parallel linkage assembly including at least two support posts pivotally coupled to at least two cross members; slidably coupling a foot support platform to the parallel linkage assembly, the foot support platform being configured to receive a user's foot; and operably coupling an interlock mechanism to each of the foot support platform and the parallel linkage assembly, the interlock mechanism being operable to selectively restrict movement of the foot support platform relative to the support posts to allow adjustment of a height of the foot support platform.

The step of slidably coupling the foot support platform to the parallel linkage assembly can include the step of slidably coupling each of a pair of collars between the foot support platform and one of the support posts, each of the pair of collars at least partially circumscribing a support post. The step of operably coupling the interlock mechanism can include the step of positioning an actuation device in a location on the leg extension device that is accessible by a user to which the leg extension device is attached while the user is supported by the leg extension device.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

1. A leg extension device, comprising:
at least two support posts;
at least two cross members, pivotally coupled to and constraining the at least two support posts in a substantially parallel relationship;
a foot support platform, configured to receive a foot of a wearer to support the wearer on the leg extension device, the foot support platform being slidably coupled aside each of the at least two support posts;
an interlock mechanism, operable to engage the foot support platform to selectively restrict movement of the foot support platform relative to the support posts to allow adjustment of a height of the foot support platform.

2. The device of claim 1, further comprising a pair of collars, each coupled between the foot support platform and one of the support posts, the collars at least partially circumscribing the support posts.

3. The device of claim 1, wherein the interlock mechanism includes an actuation device that is accessible by a user to which the leg extension device is attached while the user is supported by the leg extension device.

4. The device of claim 3, wherein the actuation device is disposed at a height equal to or greater than a height of the foot support platform when the foot support platform is in a position of maximum height adjustment.

5. The device of claim 1, wherein the interlock mechanism includes:
an actuatable pin associated with one of: at least one of the support posts, and the foot support platform; and
a plurality of receiving apertures formed in another of: the at least one of the support posts, and the foot support platform.

6. The device of claim 5, wherein the foot support platform includes a pair of actuatable pins operably coupled thereto, each pin oriented to engage one of a plurality of receiving apertures formed in the support posts, and wherein the interlock mechanism includes an actuation device that simultaneously actuates each of the pair of actuatable pins when actuated by a user of the leg extension device.

7. The device of claim 1, wherein the interlock mechanism includes:
a threaded rod oriented substantially parallel to the support posts; and
a threaded receiver coupled to the foot support platform,
wherein rotation of the threaded rod results in an elevation change of the foot support platform.

8. A leg extension device, comprising:
a support frame, comprising:
at least two support posts;
a first cross member pivotally coupled to the at least two support posts at a first elevation;
a second cross member pivotally coupled to the at least two support posts
at a second elevation relatively lower than the first elevation;
a foot support platform, movable independently from the support frame, the foot support platform slidably coupled to at least one of the support posts between the first and second cross members; and
an interlock mechanism, operable to engage the foot support platform to selectively restrict movement of the foot support platform relative to the support posts to allow adjustment of a height of the foot support platform.

9. The device of claim 8, further comprising a pair of collars, each coupled between the foot support platform and one of the support posts, the collars at least partially circumscribing the support posts.

10. The device of claim 8, wherein the interlock mechanism includes an actuation device that is accessible by a user to which the leg extension device is attached while the user is supported by the leg extension device.

11. The device of claim 10, wherein the actuation device is disposed at a height equal to or greater than a height of the foot support platform when the foot support platform is in a position of maximum height adjustment.

12. The device of claim 8, wherein the interlock mechanism includes:
an actuatable pin associated with one of: at least one of the support posts, and the foot support platform; and
a plurality of receiving apertures formed in another of: the at least one of the support posts, and the foot support platform.

13. The device of claim 12, wherein the foot support platform includes a pair of actuatable pins operably coupled thereto, each of the pins oriented to engage one of a plurality of receiving apertures formed in the support posts, and wherein the interlock mechanism includes an actuation device that simultaneously actuates each of the pair of actuatable pins when actuated by a user of the leg extension device.

14. The device of claim 8, wherein the interlock mechanism includes:
a threaded rod oriented substantially parallel to the support posts; and
a threaded receiver associated with the foot support platform,
wherein rotation of the threaded rod results in an elevation change of the foot support platform.

15. A method for forming a height-adjustable leg extension device, comprising the steps of:
providing a load-bearing parallel linkage assembly configured to simulate motion of a human foot, the parallel linkage assembly including at least two support posts pivotally coupled to at least two cross members; and
slidably coupling a foot support platform to the parallel linkage assembly, the foot support platform being configured to receive a user's foot; and
operably coupling an interlock mechanism to each of the foot support platform and the parallel linkage assembly, the interlock mechanism being operable to selectively restrict movement of the foot support platform relative to the support posts to allow adjustment of a height of the foot support platform.

16. The method of claim 15, wherein the step of slidably coupling the foot support platform to the parallel linkage assembly includes the step of slidably coupling each of a pair of collars between the foot support platform and one of the support posts, each of the pair of collars at least partially circumscribing a support post.

17. The method of claim 15, wherein the step of operably coupling the interlock mechanism includes the step of positioning an actuation device in a location on the leg extension device that is accessible by a user to which the leg extension device is attached while the user is supported by the leg extension device.

18. The method of claim 15, wherein the interlock mechanism includes:
an actuatable pin associated with one of: at least one of the support posts, and the foot support platform; and
a plurality of receiving apertures formed in another of: the at least one of the support posts, and the foot support platform.

19. The method of claim 15, wherein the foot support platform includes a pair of actuatable pins coupled thereto, each pin oriented to engage one of a plurality of receiving apertures formed in the support posts, and wherein the interlock mechanism includes an actuation device that simultaneously actuates each of the pair of actuatable pins when actuated by a user of the leg extension device while the user is supported by the leg extension device.

20. The method of claim 15, wherein the interlock mechanism includes:
a threaded rod oriented substantially parallel to the support posts; and
a threaded receiver associated with the foot support platform,
wherein rotation of the threaded rod results in an elevation change of the foot support platform.

21. A leg extension device, comprising:
at least one support post;
at least one foot support platform, pivotally coupled to the support post;
a floor pad, pivotally coupled to the support post;
an interlock mechanism, operable to engage the foot support platform to selectively restrict movement of the foot support platform relative to the floor pad to allow adjustment of a height of the foot support platform; and
a linkage assembly, coupled to each of the foot support platform and the floor pad, the linkage assembly being operable to maintain a substantially constant angular differential between the foot support platform and the floor pad as the foot support platform and the floor pad pivot relative to the support post;
the foot support platform being free to pivot relative to the support post but for one or more restraining forces applied by the linkage assembly to the foot support platform.

22. The device of claim 21, wherein the substantially constant angular differential is substantially zero degrees.

23. The device of claim 21, wherein the support post includes an upper section and a lower section telescopically engaged with one another.

24. The device of claim 23, wherein the linkage assembly is operable to maintain the substantially constant angular differential between the foot support platform and the floor pad as the upper section and the lower section are telescopically adjusted relative to one another.

25. The device of claim 21, wherein the linkage assembly includes at least one flexible cable engaged with at least one pulley.

26. The device of claim 25, wherein the linkage assembly includes a pair of flexible cables, each cable being fixedly coupled to the foot support platform.

27. The device of claim 26, wherein each of the pair of flexible cables extends from the foot support platform, about a pulley coupled to the floor pad, and back to the foot support platform.
